(19) United States
(12) Patent Application Publication
(10) Pub. No.: US 2026/0127560 A1
(43) Pub. Date: May 7, 2026

(54) MEDIATION SERVICE SYSTEM AND METHOD

(71) Applicant: HYUK JUN KWON, Paju-si (KR)

(72) Inventor: Oh Soo KWON, Seoul (KR)

(21) Appl. No.: 18/935,836

(22) Filed: Nov. 4, 2024

(51) Int. Cl. G06Q 50/00

(52) U.S. Cl. CPC G06Q 10/40

(57) ABSTRACT

The present invention relates to a mediation service system 100 connected via a network 500 to at least one customer terminal 300, a first acquaintance terminal 200, and a second acquaintance terminal 400, and the system includes a database 120 that stores customer information, customer's acquaintance information, acquaintance reliability information, notification information between acquaintances, and recommendation information; and a server 110 that, upon requests from the customer terminal 300, the first acquaintance terminal 200, or the second acquaintance terminal 400, performs intangible value transactions between acquaintances, manages customer applications, generates the customer's personal network map, determines levels based on the number of customer's personal networks and transaction frequency, and recommends as acquaintances customers whose level is above a reference level. In this embodiment of the present disclosure, it may provide various connection services, such as information sharing, sales, and bartering, by utilizing the customer's personal network, address book, and social network.

### BACKGROUND

### 1. Field

The present disclosure relates to a mediation service system and method, and more particularly, to a mediation service system and method that provides various connection services such as information sharing, sales, and bartering by utilizing a customer's personal network, address book, and social network.

### 2. Description of the Related Art

Generally, with the rapid development of communication technology and the computer field, computer communication and internet communication have become essential means for modern individuals to acquire and exchange information, and their functions and roles are increasing explosively.

As various social network services (SNS) using internet communication have become widespread, people can now manage their personal networks and enhance their influence in society through these services. Such personal networks can serve as indicators to assess an individual's sociability or personality, and can also be indicators of social influence.

There are a variety of social network services that can satisfy both personal and social purposes, and it is increasingly common for users to join a plurality of social network services and link them for management and utilization according to specific purposes.

Currently well-known social network services include various portal blogs, Twitter, Facebook, Instagram, and Kakao Story. Among these, Twitter allows users to share their thoughts, situations, etc. by recording their thoughts, situations, etc. in short sentences and allowing a plurality of subscribers who subscribe to their account to view these sentences in real time, and socially influential users actively use it in that they can communicate with their subscribers with relatively small efforts, and thus have more opportunities to communicate compared to their efforts. In the case of celebrities, they have a large number of subscribers (followers in the case of Twitter), which can increase their social influence or even shape public opinion.

The personal networks formed through such social network services have a tremendous impact in terms of immediacy and propagation power, with the help of various mobile devices and multimedia, such that even individuals who may not receive much social attention offline can attract significant social interest within a short time on social network services, sometimes even influencing public opinion.

Currently, there are social network services with various characteristics, and users choose services with their desired characteristics based on their desired objectives. For example, Kakao Story is strong in terms of a closed-group of friends, blogs are strong in terms of providing one-sided content, and Facebook is strong in terms of mutual information sharing between friends of equal status, and as a result, the number of friends is limited to a relatively small number. In the case of Twitter, as a type of microblog, the directionality of subscriptions establishes the path for information delivery, however, there are almost no restrictions on subscribers (followers), and information is delivered in real time, so the immediacy of information dissemination leads to active subscription and participation from socially influential individuals or companies.

Recently, there has been an increase in attempts to utilize such social network services for marketing or to expand one's social influence. In particular, to effectively provide information for the purpose of expanding social influence or marketing, individuals want a plurality of audiences to focus on their statements, and for this purpose, many are turning to social network services like Twitter, which are aligned with these goals, to increase their social influence.

For example, while it is still relatively easy for socially influential individuals or organizations to expand their personal networks on Twitter, ordinary people often struggle to expand their personal networks as they typically form their personal networks based on personal relationships.

The most common process of forming a personal network involves searching for the accounts of people with whom one has a relationship, requesting subscriptions (commonly known as following) to one's own account to build a certain number of subscribers, and continuously providing quality content to maintain the interest of these subscribers, encouraging them to request subscriptions in return. However, this process is characterized by a very slow rate of expansion, requiring ongoing efforts such as continuous content provision. In other words, one must continue to wait for someone to take an interest and request to follow.

Thus, for relatively quick personal network expansion, it is common to subscribe to someone else's account while hoping that they will subscribe to your own account and wait for them to respond.

This method also requires a lot of time and effort, and since it is based on mutual subscription, it is not suitable for the purpose of marketing or expanding speech rights because it does not distinguish between the speaker and the audience, and it may be difficult to use the service due to the restrictions of the service provider to reduce the service load due to such random relationship setting.

Ultimately, in order to expand one's personal network (audience) in a social network service where securing a voice is possible, a significant amount of time and effort is needed. This includes continuously providing quality content while waiting for subscribers, growing one's social influence outside the service, or carrying out separate marketing efforts to encourage users to join the social network service and subscribe to one's account. All of this involves heavy time and cost consumption.

Therefore, there is a need for a service that allows users to effectively increase their subscribers while providing mutual benefits through the use of social network services.

### PRIOR ART DOCUMENTS

### Patent Documents

(Patent Document 1) Registered U.S. Pat. No. 2,160,615

### SUMMARY

The technical problem that the present disclosure aims to solve is to address the issues of the prior art. It provides a mediation service system and method that offers various connection services, such as information sharing, sales, and bartering, by utilizing a customer's personal network, address book, and social network.

Additionally, the technical problem that the present disclosure aims to solve is to address the issues of the prior art by providing a mediation service system and method that allows customers to use various applications through a single integrated app. Furthermore, the technical problem that the present disclosure aims to solve is to address the issues of the prior art by providing a mediation service system and method that encourages transactions between acquaintances within a customer's personal network by offering points to the customer when such transactions occur.

Moreover, the technical problem that the present disclosure aims to solve is to address the issues of the prior art by providing a mediation service system and method that determines the customer's level based on the number of personal networks and offers more benefits as the customer's level increases.

In addition, the technical problem that the present disclosure aims to solve is to address the issues of the prior art by providing a mediation service system and method that determines the customer's level based on the number of personal networks and transaction frequency, and recommends high-level customers as acquaintances.

Finally, the technical problem that the present disclosure aims to solve is to address the issues of the prior art by providing a mediation service system and method that, during transactions between acquaintances, initially offers reliability and then enhances transaction safety by utilizing an escrow system.

The mediation service system according to the features of the present invention, which addresses the aforementioned problems, is
a mediation service system 100 connected via a network 500 to at least one customer terminal 300, a first acquaintance terminal 200, and a second acquaintance terminal 400, the mediation service system comprising:
a database 120 that stores customer information, customer's acquaintance information, acquaintance reliability information, notification information between acquaintances, and application information; and
a server 110 that, upon requests from the customer terminal 300, the first acquaintance terminal 200, or the second acquaintance terminal 400, performs intangible value transactions between acquaintances, manages customer applications, generates a customer's personal network map, determines levels based on the number of personal networks and transaction frequency, and recommends customers as acquaintances whose level is above a reference level.

The database 120 includes:
a customer information database (DB) 121 that stores customer information;
an acquaintance information database (DB) 122 that stores customer's acquaintance information and the customer's acquaintance personal network map;
a reliability information database (DB) 123 that stores the reliability information of acquaintances;
a notification information database (DB) 124 that stores necessary information requested by acquaintances;
an application information database (DB) 125 that stores the information of applications used by the customer; and
a recommendation information database (DB) 126 that stores recommendation information about individuals recommended as acquaintances of the customer.

The server 110 includes:
a membership management unit 111 that manages the customers in the customer information database 121;
an acquaintance management unit 112 that generates and stores customer's acquaintance information and personal network maps in the acquaintance information database 122;
a reliability controller 113 that generates reliability information for acquaintances and stores it in the reliability information database 123;
a notification mediation unit 114 that stores the necessary information requested by acquaintances in the notification information database 124 and mediates transactions between acquaintances by referring to the notification information database;
an application management unit 115 that stores and controls the applications used by the customer in the application information database 125; and
a recommendation unit 117 that determines the customer's level based on the number of customer's personal networks and transaction frequency and recommends customers as acquaintances whose level is above a reference level.

The recommendation unit 117 recommends as acquaintances customers who reside within a predetermined distance from the customer's location and whose personal network level and transaction frequency level are each above the reference level.

The recommendation unit 117 recommends as acquaintances customers who reside within a predetermined distance from the customer's location and whose personal network level is above the reference level, and continues to recommend customers whose personal network level exceeds the reference level if the increase in the number of the customer's personal network during a certain period is greater than the average increase.

The recommendation unit 117 recommends as acquaintances customers who reside within a predetermined distance from the customer's location and whose transaction level is above the reference level, and continues to recommend customers with a transaction level above the reference level if the number of transactions the customer conducts exceeds the average transaction frequency during a certain period.

The mediation service method according to the features of the present disclosure, which addresses the aforementioned issues, is
a mediation service method of a mediation service system 100 connected via a network 500 to at least one customer terminal 300, a first acquaintance terminal 200, and a second acquaintance terminal 400, the mediation service method comprising:
connecting the customer terminal 300, the first acquaintance terminal 200, or the second acquaintance terminal 400 to the server;
the server 110 authenticating the customer;
the server providing available service information once authentication is completed;
the server 110 determining the selected service if the customer terminal 300, the first acquaintance terminal 200, or the second acquaintance terminal 400 selects the desired service;
the server 110 generating the customer's acquaintance information and personal network map and storing it in the acquaintance information database 122 if the selected service is acquaintance management;
the server 110 receiving and registering notification information and mediating the process if the selected service is notification processing; and
if the selected service is acquaintance recommendation, the sever 110 determining the customer's level based on the number of personal networks and transaction frequency, and recommending customers as acquaintances whose level is above a reference level.

The server 110 generating the customer's acquaintance information and personal network map and storing it in the acquaintance information database 122 is characterized by generating reliability information for acquaintances and storing it in the reliability information database 123.

The server 110 receiving and registering notification information and mediating the process is characterized by displaying job-related notification information to the customer's acquaintances when the notification relates to a job posting, allowing the acquaintances to provide information regarding the job posting.

The server 110 receiving and registering notification information and mediating the process is characterized by displaying sales-related notification information to the customer's acquaintances when the notification relates to a sale of goods, allowing the acquaintances to provide information regarding the sale of goods.

If the selected service is acquaintance recommendation, in the server 110 determining the customer's level based on the number of personal networks and transaction frequency, and recommending customers as acquaintances whose level is above a reference level, the recommendation unit 117 is characterized by recommending as acquaintances those customers who reside within a predetermined distance from the customer's location and whose personal network level is above the reference level, and then if, within a certain period, the increase in the number of the customer's personal network exceeds the average increase, the recommendation unit continues to recommend customers whose personal network level exceeds the reference level.

If the selected service is acquaintance recommendation, in the server 110 determining the customer's level based on the number of personal networks and transaction frequency, and recommending customers as acquaintances whose level is above a reference level, the recommendation unit 117 is characterized by recommending as acquaintances those customers who reside within a predetermined distance from the customer's location and whose transaction level is above the reference level, and then if, within a certain period, the customer's transaction frequency exceeds the average transaction frequency, the recommendation unit continues to recommend customers whose transaction level is above the reference level.

The method further includes, if the selected service is application management, the server 110 receiving application information and managing it as the registered application of the customer or acquaintance.

In the embodiment of the present disclosure, it is possible to provide a mediation service system and method that offers various connection services such as information sharing, sales, and bartering by utilizing a customer's personal network, address book, social network, and the like.

In addition, in the embodiment of the present disclosure, it is possible to provide a mediation service system and method that allows customers to use various applications through a single integrated app.

Furthermore, in the embodiment of the present disclosure, it is possible to provide a mediation service system and method that encourages transactions between acquaintances within a customer's personal network map by providing points to the customer when such transactions occur.

Moreover, in the embodiment of the present disclosure, it is possible to provide a mediation service system and method that determines the customer's level based on the number of personal networks, and offers more benefits as the customer's level increases.

In addition, in the embodiment of the present disclosure, it is possible to provide a mediation service system and method that determines the customer's level based on the number of personal networks and the number of transactions, and recommends high-level customers as acquaintances.

Furthermore, in the embodiment of the present disclosure, it is possible to provide a mediation service system and method that primarily provides reliability during transactions between acquaintances, and subsequently enhances transaction safety by utilizing an escrow system.

### BRIEF DESCRIPTION OF THE DRAWINGS

FIG. 1 is a configuration diagram of the mediation service system according to the embodiment of the present disclosure.

FIG. 2 is a configuration diagram of the seller terminal.

FIG. 3 is a flowchart illustrating the operation of the mediation service method according to the embodiment of the present disclosure.

FIG. 4 is a diagram showing an example of the personal network map of the mediation service system according to the embodiment of the present disclosure.

FIG. 5 is a diagram showing an example of the level based on the number of personal networks in the mediation service system according to the embodiment of the present disclosure.

FIG. 6 is a diagram showing an example of transactions in the mediation service system according to the embodiment of the present disclosure.

FIG. 7 is a diagram showing an example of point distribution in the mediation service system according to the embodiment of the present disclosure.

### DETAILED DESCRIPTION OF THE EMBODIMENTS

Hereinafter, the embodiments of the present disclosure will be described in detail with reference to the accompanying drawings so that those skilled in the technical field to which the present invention pertains can easily carry out the invention. However, the present invention can be implemented in various different forms and is not limited to the embodiments described herein. Parts that are irrelevant to the explanation have been omitted from the drawings to clearly describe the present invention, and similar reference numbers have been assigned to similar parts throughout the specification.

Throughout the specification, when a part is described as “including” a certain component, it means that other components may be included, rather than excluding other components unless explicitly stated otherwise.

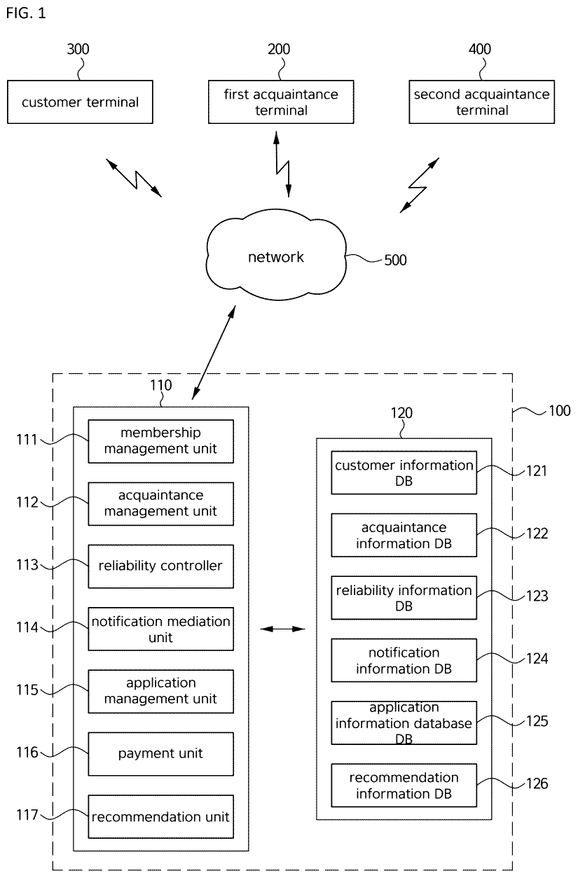

FIG. 1 is a configuration diagram of the mediation service system according to the embodiment of the present disclosure.

Referring to FIG. 1, the mediation service system according to the embodiment of the present disclosure includes:
a mediation service system 100 connected via a network 500 to at least one customer terminal 300, a first acquaintance terminal 200, and a second acquaintance terminal 400;
a database 120 that stores customer information, customer's acquaintance information, acquaintance reliability information, notification information between acquaintances, and application information; and
a server 110 that, upon requests from the customer terminal 300, the first acquaintance terminal 200, or the second acquaintance terminal 400, performs intangible value transactions between acquaintances, manages customer applications, generates the customer's personal network map, determines levels based on the number of customer's personal networks and transaction frequency, and recommends customers as acquaintances whose level is above a reference level.

The database 120 includes:
a customer information database 121 that stores customer information such as residence, contact details, personal information, ID, and password;
an acquaintance information database 122 that stores information of acquaintances registered as the customer's acquaintances and a personal network map that represents the connections between the customer and acquaintances in the form of a map;
a reliability information database 123 that stores the reliability information of acquaintances;
a notification information database 124 that stores notification information, including job postings requested by acquaintances and transaction information of goods;
an application information database 125 that stores application programs downloaded and executed on the customer terminal; and
a recommendation information database 126 that stores recommendation information for acquaintances recommended to the customer.

The server 110 includes:
a membership management unit 111 that manages customers in the customer information database 121;
an acquaintance management unit 112 that generates customer's acquaintance information and personal network maps and stores them in the acquaintance information database 122;
a reliability controller 113 that generates reliability information for acquaintances and stores it in the reliability information database 123;
a notification mediation unit 114 that stores necessary information requested by acquaintances in the notification information database 124 and mediates transactions between acquaintances by referring to the notification information database 124;
an application management unit 115 that stores and controls applications used by the customer in the application information database 125;
a payment unit 116 that ensures secure payments using an escrow system; and
a recommendation unit 117 that determines the customer's level based on the number of personal networks and transaction frequency, and recommends customers as acquaintances whose level is above a reference level.

The recommendation unit 117 recommends as acquaintances those customers who reside within a predetermined distance from the customer's location and whose personal network level and transaction frequency level are both above the reference level.

The recommendation unit 117 is characterized in that it recommends as acquaintances those customers who reside within a predetermined distance from the customer's location and whose personal network level is above the reference level, and continues to recommend customers whose personal network level is above the reference level if the increase in the number of the customer's personal network exceeds the average increase during a certain period.

The recommendation unit 117 is characterized in that it recommends as acquaintances those customers who reside within a predetermined distance from the customer's location and whose transaction level is above the reference level, and continues to recommend customers whose transaction level is above the reference level if the customer's transaction frequency exceeds the average transaction frequency during a certain period.

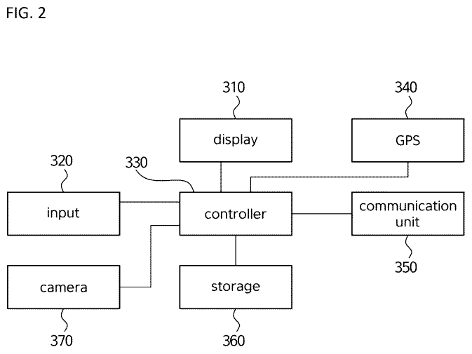

FIG. 2 is an internal block diagram of the customer terminal 300 from FIG. 1.

Referring to FIG. 2, the customer terminal 300 includes an input 320, a GPS 340, a storage 360, a camera 370, a communication unit 350, a controller 330, and a display 310.

The display 310 displays various screen information according to the selection of the input 320.

The input 320 may include input devices such as a touch panel or a keypad, and is used by the user to make menu selections.

The GPS 340 receives GPS signals from at least two GPS satellites to generate and output its own location information. If necessary, the GPS 340 may be omitted, and location information provided by a mobile communication company may be used instead.

The storage 360 may store application programs provided by the server 110, and may also store information captured by the camera.

The camera 370 takes pictures according to the selection of the input 320.

The controller 330 displays content received from the server 110 on the display 310, and transmits information inputted via the input 320 to the server 110. Additionally, the controller 330 may download application programs from the server 110, store them in the storage 360, and execute them.

The communication unit 350 may transmit and receive information under the control of the controller 330, and utilize various wireless internet or other wireless communication networks such as Bluetooth, Wi-Fi, 3G, and 4G.

The server 110 allows the seller terminal 300 to access it via mobile or web links.

The customer terminal 300, internet-accessible PCs, smartphones, and tablet PCs, are included, and the first acquaintance terminal 200 and the second acquaintance terminal 400 have the same configuration as the customer terminal 300.

The reliability controller 113 is characterized in that it allows the customer to set the reliability of an acquaintance with a maximum score of 100 points, and the set score automatically increases by 1 point for each increase in successful transaction, while 10 points are deducted for incomplete or unsatisfactory transactions, and calculates transaction stability using the reliability score, where the transaction stability is calculated as: (my acquaintance's reliability*0.5)+(0.5*(sum of n-th degree acquaintances' reliability/n)).

The operation of the mediation service system according to the embodiment of the present disclosure, with the above configuration, is explained as follows.

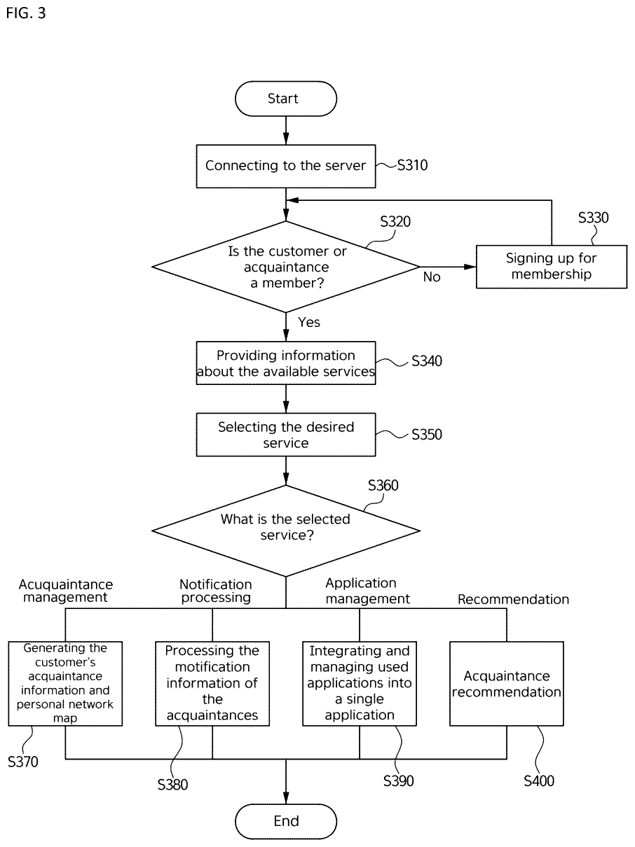

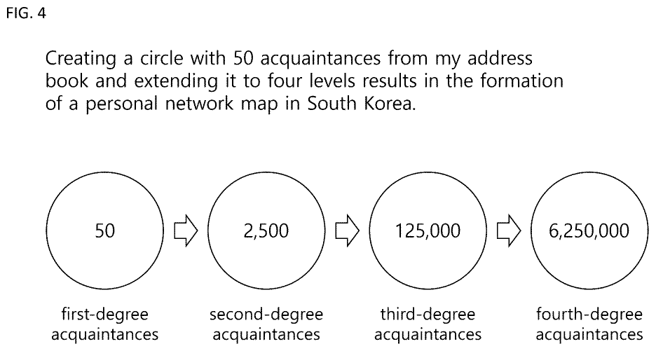

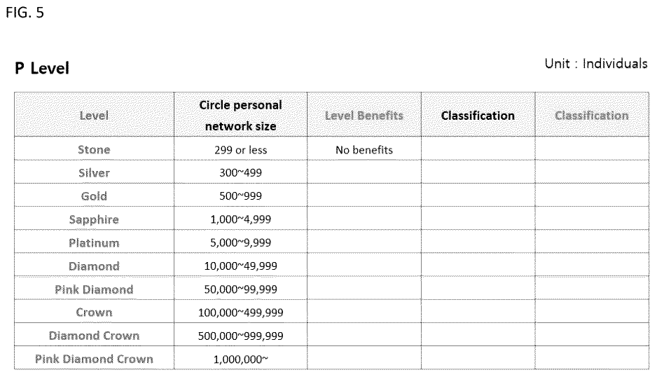

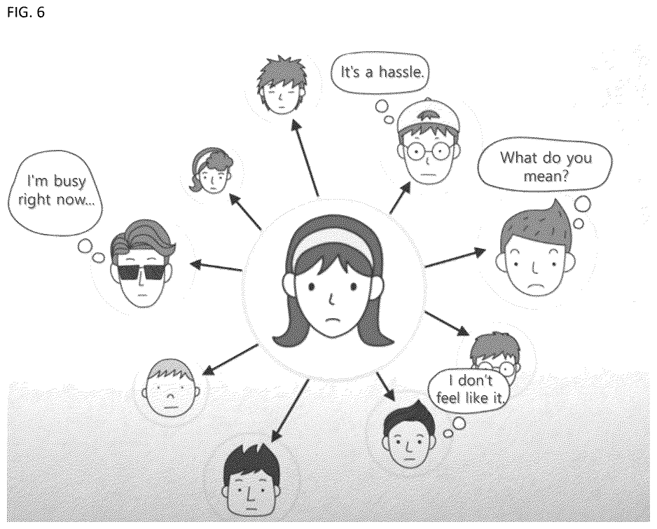

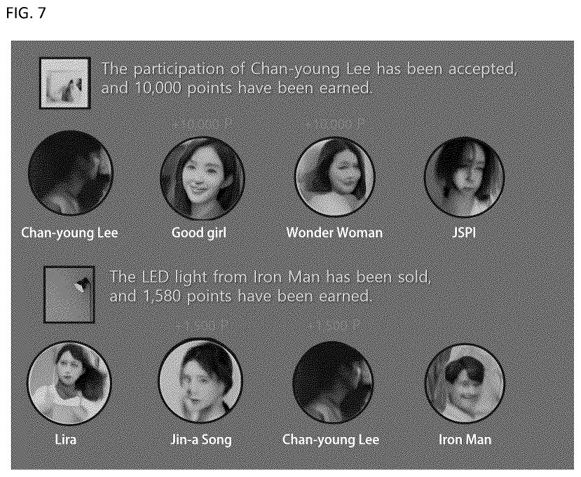

FIG. 3 is a flowchart illustrating the operation of the mediation service method according to the embodiment of the present disclosure, FIG. 4 is a diagram showing an example of the personal network map in the mediation service system according to the embodiment of the present disclosure, FIG. 5 is a diagram showing an example of the levels based on the number of personal networks in the mediation service system according to the embodiment of the present disclosure, FIG. 6 is a diagram showing an example of transactions in the mediation service system according to the embodiment of the present disclosure, and FIG. 7 is a diagram showing an example of point distribution in the mediation service system according to the embodiment of the present disclosure.

Referring to FIG. 3, first, the customer terminal 300, the first acquaintance terminal 200, or the second acquaintance terminal 400 connects to the server 110 (S310). The customer or acquaintances may sign up for membership in advance and register their own information or acquaintance information. In the present disclosure, an acquaintance refers to a person who has a personal relationship with the customer and has become a subscriber to the customer's account by requesting a subscription (commonly known as “following”), or someone registered as an acquaintance among social network friends, schoolmates, friends of friends, relatives, coworkers, alumni, or neighborhood acquaintances. Additionally, the acquaintances of acquaintances may also be registered as acquaintances of the customer.

Next, the membership management unit 111 of the server 110 performs authentication (S320).

If the customer, first acquaintance, or second acquaintance is not a member, they sign up for membership (S330) and are authenticated again.

Once authentication is completed, the server 110 provides information about the available services (S340).

At this point, the customer or acquaintances may select and use the service they want. When the customer terminal 300, first acquaintance terminal 200, or second acquaintance terminal 400 selects the desired service (S350), the server 110 determines the selected service (S360).

If the selected service is acquaintance management, the acquaintance management unit 112 of the server 110 generates the customer's acquaintance information and personal network map, and stores it in the acquaintance information database 122 (S370).

For example, the acquaintance management unit 112 may receive acquaintance information directly from the customer, or, with the customer's consent, it may receive information about acquaintances registered as friends on various sites or applications the customer has joined, and register them as acquaintances.

Referring to FIG. 4, a personal network map may be created by forming a circle with 50 acquaintances from the address book, 2,500 second-degree acquaintances (acquaintances of acquaintances), 125,000 third-degree acquaintances (acquaintances of second-degree acquaintances), and 6,250,000 fourth-degree acquaintances (acquaintances of third-degree acquaintances). As the personal network map expands, it may connect everyone in the world, depending on the need.

Additionally, the reliability controller 113 of the server 110 generates reliability information for acquaintances and stores it in the reliability information database. Here, reliability refers to the reliability of acquaintances, and the acquaintance may decide the reliability score, which may automatically increase or decrease based on transactions. For example, if the customer sets and registers the reliability score of the first acquaintance to 90 out of 100 points, the score may automatically increase by 1 point for each increase in successful transaction and decrease by 10 points for incomplete or unsatisfactory transactions.

Additionally, transaction stability may be calculated using reliability. Specifically, transaction stability is calculated as (my acquaintance's reliability*0.5+0.5*(sum of n-th degree acquaintances' reliability/n)), with more weight given to the reliability of my acquaintance. This weight may be adjusted as needed.

For example, if I want to conduct a transaction with my acquaintance's second-degree acquaintance, and I have set my acquaintance's reliability to 90 points, my acquaintance has set the reliability of the first-degree acquaintance to 60 points, and the first-degree acquaintance has set the reliability of the second-degree acquaintance to 60 points, then the transaction stability is calculated as (90*0.5+0.5*(60+60)/2), resulting in 75 points.

Therefore, when a customer wishes to conduct a transaction with a second-degree acquaintance, they may evaluate the transaction stability in advance and proceed with a secure transaction.

Additionally, the acquaintance management unit 112 determines the customer's level based on the number of customer's personal networks, and more benefits are provided as the level increases.

For example, as shown in FIG. 5, levels are classified as Stone, Silver, Gold, etc., based on the number of personal networks, and as the level increases, more benefits such as point rewards or preferential discounts on transactions may be provided.

If the selected service is notification processing, the notification mediation unit 114 of the server 110 receives and registers notification information from the customer terminal 300 and then mediates the process (S380).

If the notification information is related to a job posting, the notification information is displayed to the customer's acquaintances, allowing them to be informed about the job opportunity. The acquaintances may then recommend suitable candidates to the job poster. If necessary, the notification mediation unit 114 may determine suitable acquaintances for the job and connect them with the job poster who posted the notification.

Additionally, the notification mediation unit 114 may provide reliability and transaction stability information to both parties involved to reference during the job-related transaction.

If the notification information is related to the sale of goods, the notification information related to the sale of goods is displayed to the customer's acquaintances, allowing them to be informed about the goods for sale. If the acquaintances need the goods, they may purchase them from the customer. If necessary, the notification mediation unit 114 may determine suitable acquaintances for the sale information and connect them with the customer who posted the notification information.

Additionally, reliability and transaction stability information is provided to both parties for reference during the transaction, and if such a transaction is completed and the transaction involves a monetary exchange, such as a sale, the payment unit 116 ensures the transaction is securely completed using an escrow system.

Furthermore, as shown in FIG. 6, the notification mediation unit 114 may mediate various services between the customer and acquaintances, such as private tutoring, part-time jobs, bartering, agricultural product sales, purchasing of needed second-hand items, translation outsourcing, and more.

In cases where such a transaction is completed and the transaction involves monetary exchange, the payment unit ensures that the transaction is securely completed using an escrow system.

When the transaction is completed, as shown in FIG. 7, points are awarded to the customer or the acquaintance, and the customer may assist in facilitating transactions between acquaintances.

Meanwhile, if the selected service is acquaintance recommendation, the server 110 determines the customer's level based on the number of customer's personal networks and transaction frequency, and recommends as acquaintances the customers whose level is above a reference level (S400).

Here, the recommendation unit 117 is characterized in that it recommends as first-degree acquaintances those customers who reside within a predetermined distance (selected from 10 to 100 km) from the customer's location and whose personal network level is above the reference level, and after considering them as first-degree acquaintances, if the number of the customer's personal network increases more than the average increase over a certain period, it continues to recommend the customers whose personal network level is above the reference level. For example, first-degree acquaintances are classified as Stone if the first-degree acquaintances are less than 100, as Silver if the first-degree acquaintances are more than or equal to 100 and less than 1,000, as Gold if the first-degree acquaintances are more than or equal to 1,000 and less than 10,000, and as VIP if the first-degree acquaintances are more than or equal to 10,000. The reference level may be set at the Gold level. If the customer's personal network increases by 10 people in a month, and this increase exceeds the average growth of 7 people for all customers, the recommendation unit will continue to periodically recommend customers whose personal network level exceeds the reference level. If not, the recommendations are discontinued. However, the customer may request recommendations again if desired.

Additionally, the recommendation unit 117 is characterized in that it recommends as first-degree acquaintances those customers who reside within a predetermined distance (selected from 10 to 100 km) from the customer's location and whose transaction level is above the reference level, and after considering them as first-degree acquaintances, if the customer's transaction frequency is over the average transaction frequency over a certain period, it continues to recommend as first-degree acquaintances those customers whose transaction level is above the reference level.

For example, if the customer's transaction frequency is less than 5 per month on average, they are classified as Stone; if the transaction frequency is more than or equal to 5 and less than 20, they are classified as Silver; if the transaction frequency is more than or equal to 20 and less than 50, they are classified as Gold; and if the transaction frequency is more than or equal to 50, they are classified as VIP. The reference level may be set at the Gold level. After receiving a recommendation, if the customer's transaction frequency reaches 20 in a month, which is greater than the average transaction frequency of 15, the recommendation unit 117 will continue to provide recommendations.

If not, the recommendation unit 117 will stop the recommendations. However, if the customer requests recommendations again, the recommendations may resume.

If the customer likes one of the recommended acquaintances, they may register them as an acquaintance.

In some cases, the recommendation unit may change the selection criteria from within a predetermined distance (selected from 10 to 100 km) to selecting from the customer's second-degree to fourth-degree acquaintances. That is, the recommendation unit 117 recommends as first-degree acquaintances those customers whose personal network level is above the reference level among the customer's second-degree to fourth-degree acquaintances. If the number of the customer's personal network increases more than the average increase over a certain period, the recommendation unit continues to recommend as first-degree acquaintances those customers whose personal network level exceeds the reference level.

The recommendation unit 117 also recommends as first-degree acquaintances those customers whose transaction level is above the reference level among the customer's second-degree to fourth-degree acquaintances, and then if the customer's transaction frequency exceeds the average transaction frequency over a certain period, the recommendation unit continues to recommend as first-degree acquaintances those customers whose transaction level exceeds the reference level.

Meanwhile, if the selected service is application management, the application management unit 115 of the server 110 may download and execute applications on the customer's terminal.

Additionally, the application management unit 115 of the server 110 may collect application information in terminals used by the customer, first-degree acquaintances, or second-degree acquaintances, and manage the applications registered by the customer or acquaintances (S390). The application management unit 115 may also provide the application information of acquaintances to the customer's terminal, allowing the customer to check the necessary application information and download the required applications by accessing the app store.

The application management section 115 allows multiple applications registered by the customer or acquaintances to be executed within a single integrated application with just one operation of the integrated application.

In the embodiment of the present disclosure, it is possible to provide various connection services such as information sharing, sales, and bartering by utilizing the customer's personal network, address book, social network, and the like.

Furthermore, in the embodiment of the present disclosure, it allows customers to use customer's various applications through a single integrated app.

Additionally, in the embodiment of the present disclosure, if transactions occur between acquaintances in the customer's personal network map, points are awarded to the customer to encourage further transactions.

Additionally, in the embodiment of the present disclosure, it is possible to determine the customer's level based on the number of personal networks, and more benefits may be provided as the level increases.

Furthermore, in the embodiment of the present disclosure, it is possible to determine the customer's level based on the number of customer's personal networks and the transaction frequency, and recommend high-level customers as acquaintances.

Additionally, in the embodiment of the present disclosure, when transactions occur between acquaintances, reliability is initially provided, and the escrow system may be used subsequently to enhance transaction safety.

The embodiments of the present disclosure described above are not limited to being implemented only through devices and methods. They may also be implemented through a program that realizes the functions corresponding to the configuration of the embodiments of the present disclosure, or a recording medium on which the program has been recorded. Such implementations may be easily realized by experts in the technical field to which the present invention pertains, based on the description of the embodiments provided above.

While the embodiments of the present disclosure have been described in detail, the scope of the present invention is not limited thereto, and various modifications and improvements made by those skilled in the art using the basic concepts defined in the following claims are also within the scope of the present invention.

1. A mediation service system, comprising:
a customer terminal (300) including a GPS receiver configured to receive GPS signals from at least two GPS satellites to generate and output its own location information;
a database (120) that stores customer information, customer's acquaintance information, and acquaintance reliability information;
a server (110) that performs mediation transactions between acquaintances based on requests from the customer terminal (300), a first acquaintance terminal (200), or a second acquaintance terminal (400), manages customer applications, generates a customer's personal network map, determines the customer's personal network level based on a number of customer's personal networks, determines a transaction frequency level based on the customer's transaction frequency, and recommends as acquaintances customers whose personal network level is above a reference personal network level or whose transaction frequency level is above a reference transaction frequency level,
wherein the database (120) includes:
a customer information database (121) that stores customer information,
an acquaintance information database (122) that stores customer's acquaintance information and the personal network map of customer acquaintances,
a reliability information database (123) that stores reliability information of acquaintances,
a notification information database (124) that stores information related to job postings or sales requested by acquaintances, and
a recommendation information database (126) that stores information about individuals recommended as acquaintances of the customer;
wherein the server (110) includes:
a membership management unit (111) that manages customers in the customer information database (121),
an acquaintance management unit (112) that generates and stores customer's acquaintance information and personal network maps in the acquaintance information database (122),
a reliability controller (113) that generates reliability information for acquaintances and stores it in the reliability information database (123), the reliability information including a reliability score for each of the acquaintances,
a notification mediation unit (114) that stores information related to job postings or sales requested by acquaintances in the notification information database (124) and mediates transactions related to job postings or sales between acquaintances by referring to the notification information database (124),
an application management unit (115),
a payment unit (116), and
a recommendation unit (117) that determines the customer's personal network level based on the number of the customer's personal networks and the transaction frequency level based on the customer's transaction frequency, and recommends as acquaintances customers whose personal network level is above the reference personal network level or whose transaction frequency level is above the reference transaction frequency level;
wherein the reliability controller (113) increases the reliability score for each of the acquaintances by 1 point for each increase in a number of successful transactions of a corresponding acquaintance of the acquaintances and decreases the score by 10 points for each incomplete or unsatisfactory transaction, and evaluates a transaction stability before conducting a transaction with an n^{th}-degree acquaintance of the customer's acquaintance, the transaction stability being calculated as (the reliability score for the customer's acquaintance*0.5+0.5*(a sum of reliability scores for first-to n^{th}-degree acquaintances of the customer's acquaintance)/n);
wherein the recommendation unit (117) receives the location information from the customer terminal (300), recommends as first-degree acquaintances those customers who reside within a predetermined distance selected from 10 to 100 km from the customer's location determined based on the location information and whose personal network level is above the reference personal network level, and continues to recommend as first-degree acquaintances customers whose personal network level is above the reference personal network level if the number of the customer's personal network increases more than an average increase over a certain period;
wherein the payment unit (116) ensures secure payments for the mediation transactions between acquaintances using an escrow system based on the reliability score and the transaction stability;
wherein the application management unit (115) causes multiple registered applications of the customer or acquaintances to execute within a single integrated application with one operation of the single integrated application; and
wherein the recommendation unit (117) classifies the network level as Stone if the first-degree acquaintances are less than 100, as Silver if the first-degree acquaintances are more than or equal to 100 and less than 1,000, as Gold if the first-degree acquaintances are more than or equal to 1,000 and less than 10,000, and as VIP if the first-degree acquaintances are more than or equal to 10,000.
